(19) United States
(12) Patent Application Publication
(10) Pub. No.: US 2009/0257508 A1
(43) Pub. Date: Oct. 15, 2009

(54) METHOD AND SYSTEM FOR ENABLING VIDEO TRICK MODES

(76) Inventors: Gaurav Aggarwal, Andover, MA (US); Marcus Kellerman, San Diego, CA (US); David Erickson, San Clemente, CA (US); Robert Tosi, Littleton, MA (US); Wade Wan, Orange, CA (US)

Correspondence Address: MCANDREWS HELD & MALLOY, LTD, 500 WEST MADISON STREET, SUITE 3400, CHICAGO, IL, 60661, US

(21) Appl. No.: 12/400,250

(22) Filed: Mar. 9, 2009

Related U.S. Application Data
(60) Provisional application No. 61/043,787, filed on Apr. 10, 2008.

(51) Int. Cl. H04N 7/12

(52) U.S. Cl. 375/240.25; 375/E07.027

(57) ABSTRACT

A video processing system is operable to perform one or more display queue trick (DQT) operations utilizing decoded frames queued in memory. The decoded frames are generated from the start of random access points (RAPs) in frame segments in an encoded video stream. Location of RAPs may be determined during decoding of the encoded video stream. Exemplary encoding scheme comprise MPEG, AVC and/or VC1. The DQT modes include forward and/or reverse display modes. The used frames are selected based on determination of DQT mode parameters, queuing limitations and/or frame properties of selected and/or unselected frames in the frame segments. Frame properties comprise frame discardability and/or display inter-frame dependencies between selected and/or unselected frames. The video processing system is operable to jump to preceding and/or subsequent RAPs during DQT mode operations. The video processing system is also operable to skip one or more RAPs during such jumps.

### CROSS-REFERENCE TO RELATED APPLICATIONS/INCORPORATION BY REFERENCE

This patent application makes reference to, claims priority to and claims benefit from U.S. Provisional Application Ser. No. 61/043,787 (Attorney Docket No. 19468US01) filed on Apr. 10, 2008.

The above stated application is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to video processing. More specifically, certain embodiments of the invention relate to a method and system for enabling video trick modes.

### BACKGROUND OF THE INVENTION

Television broadcasts are generally transmitted by television head-ends over broadcast channels, via RF carriers. TV head-ends may comprise terrestrial TV head-ends, Cable-Television (CATV), satellite TV head-ends and/or internet television (IPTV) head-ends. Terrestrial TV head-ends may utilize, for example, a set of terrestrial broadcast channels, which in the U.S. may comprise, for example, channels 2 through 69. Cable-Television (CATV) broadcasts may utilize even greater number of broadcast channels. TV broadcasts comprise transmission of video and/or audio information, wherein the video and/or audio information may be encoded into the broadcast channels via one of plurality of available modulation schemes. TV Broadcasts may utilize analog and/or digital modulation format. In analog television systems, picture and sound information are encoded into, and transmitted via analog signals, wherein the video/audio information may be conveyed via broadcast signals, via amplitude and/or frequency modulation on the television signal, based on analog television encoding standard. Analog television broadcasters may, for example, encode their signals using NTSC, PAL and/or SECAM analog encoding and then modulate these signals onto a VHF or UHF RF carriers, for example.

In digital television (DTV) systems, television broadcasts may be communicated by terrestrial, cable and/or satellite head-ends via discrete (digital) signals, utilizing one of available digital modulation schemes, which may comprise, for example, QAM, VSB, QPSK and/or OFDM. Because the use of digital signals generally requires less bandwidth than analog signals to convey the same information, DTV systems may enable broadcasters to provide more digital channels within the same space otherwise available to analog television systems. In addition, use of digital television signals may enable broadcasters to provide high-definition television (HDTV) broadcasting and/or to provide other non-television related service via the digital system. Available digital television systems comprise, for example, ATSC, DVB, DMB-T/H and/or ISDN based systems. Video and/or audio information may be encoded into digital television signals utilizing various video and/or audio encoding and/or compression algorithms, which may comprise, for example, MPEG-1/2, MPEG-4 AVC, MP3, AC-3, MC and/or HE-AAC.

TV sets (TVs) may be utilized to output audiovisual streams, which may comprise TV broadcasts, telecasts and/or localized Audio/Video (A/V) feeds from one or more available consumer audiovisual devices, such as videocassette recorders (VCRs) and/or Digital Video Disc (DVD) players. Audiovisual streams may be inputted directly into the TVs and/or via one or more specialized set-top boxes that may enable providing any necessary processing operations, via one or more of available types of connectors including, but not limited to, F-connectors, S-video, composite and/or video component connectors.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for enabling video trick modes, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating a video display that is operable to utilize various types of TV broadcasts and/or feeds from audiovisual devices, in accordance with an embodiment of the invention.

FIG. 2 is a block diagram that illustrates an exemplary video system that utilizes display queue trick (DQT) modes to perform trick mode operations, in accordance with an embodiment of the invention.

FIG. 3A is a block diagram that illustrates an encoded bitstream that corresponds to a frame stream with random access points, which may be utilized in accordance with an embodiment of the invention.

FIG. 3B is a block diagram that illustrates various methods in utilizing display queue trick (DQT) modes to perform forward trick mode operations, in accordance with an embodiment of the invention.

FIG. 3C is a block diagram that illustrates use of display queue trick (DQT) modes to perform reverse trick mode operations, in accordance with an embodiment of the invention.

FIG. 3D is a block diagram that illustrates use of display queue trick (DQT) modes to perform trick mode operations with video streams that comprise reference and discardable frames, in accordance with an embodiment of the invention.

FIG. 3E is a block diagram that illustrates use of display queue trick (DQT) modes to perform trick mode operations with video streams with different encoding/display orders, in accordance with an embodiment of the invention.

FIG. 4 is a flow chart that illustrates use of display queue trick (DQT) modes to perform trick mode operations, in accordance with an embodiment of the invention.

### DETAILED DESCRIPTION OF THE INVENTION

Certain embodiments of the invention may be found in a method and system for enabling video trick modes. In various embodiments of the invention, a video system may be operable to perform one or more display queue trick (DQT) operations utilizing decoded frames, which may be queued in memory within and/or external to said video system. The decoded frames may be generated from start of random access points (RAPs) in frame segments in an encoded video stream which comprises a plurality of RAPs. The video stream may be encoded utilizing one or more encoding schemes, including for example MPEG-1/2, AVC and/or VC1. The DQT modes may comprise forward and/or reverse display modes, and may comprise such operations as fast-forwarding, rewinding and/or reverse-playing. The frames utilized during DQT modes may be selected based on a determination of DQT mode parameters, queuing limitations and/or frame properties of selected and/or unselected frames in the frame segments. The parameters of DQT modes may comprise, for example, speed of display, direction, quality of motion rendition and/or desired visual effect. Frame properties may comprise decoding and/or display order, frame discardability and/or display inter-frame dependencies between selected and/or unselected frames. The used frames may be selected from the start of the RAPs in the frame segments, and/or may be non-contiguous frames within the frame segments. The video processing system may be operable to jump to preceding and/or subsequent RAPs during DQT mode operations to facilitate use of frames in subsequent and/or preceding frame segments, respectively. The video processing system may also be operable to skip one or more RAPs during jumps to following and/or preceding frame segments during DQT modes.

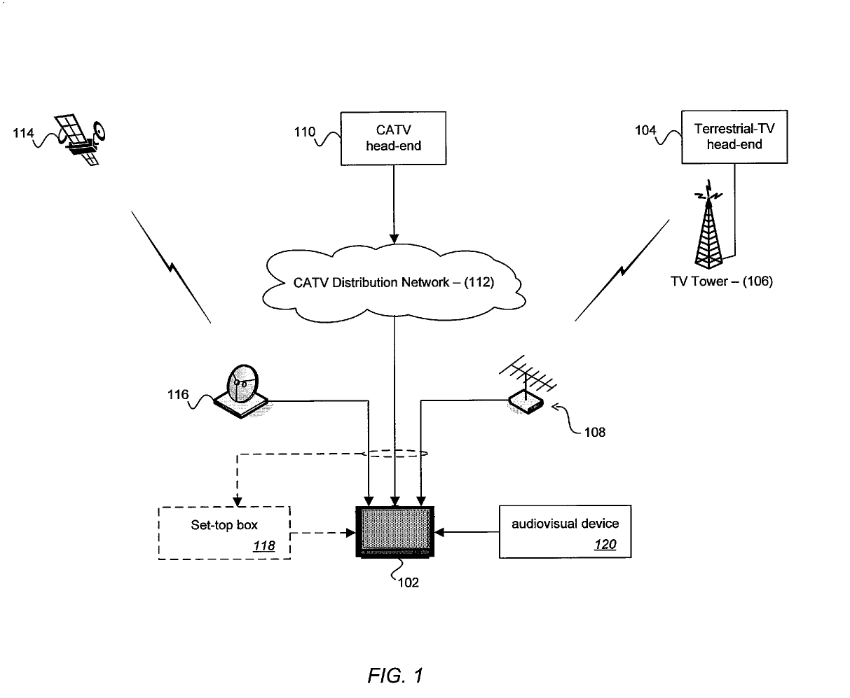

FIG. 1 is a block diagram illustrating a video display that is operable to utilize various types of TV broadcasts and/or feeds from audiovisual devices, in accordance with an embodiment of the invention. Referring to FIG. 1, there is shown a video display device 102, a terrestrial-TV head-end 104, a TV tower 106, a TV antenna 108, a cable-TV (CATV) head-end 110, a cable-TV (CATV) distribution network 112, a satellite-TV head-end 114, a satellite-TV receiver 116, a set-top box 118, and an audiovisual device 120.

The video display device 102 may comprise suitable logic, circuitry and/or code that may enable outputting and/or displaying audiovisual streams. Specifically, the video display device 102 may enable displaying TV and/or video streams that may be digitally encoded. For example, the video display device 102 may comprise a digital TV set that may be utilized in displaying and/or outputting digitally encoded audio/visual signals received and/or processed directly via the digital TV set and/or via an external device, for example the set-top box 118.

The terrestrial-TV head-end 104 may comprise suitable logic, circuitry and/or code that may enable over-the-air broadcast of TV signals, via one or more of TV towers 106. The terrestrial-TV head-end 104 may be enabled to broadcast digitally encoded terrestrial TV signals. The TV antenna 108 may comprise suitable logic, circuitry and/or code that may enable reception of TV signals transmitted by the terrestrial-TV head-end 104, via the TV tower 106. The CATV head-end 110 may comprise suitable logic, circuitry and/or code that may enable communication of cable-TV signals. The CATV head-end 110 may be enabled to broadcast digital format cable-TV signals. The CATV distribution network 112 may comprise suitable distribution systems that may enable forwarding of communication from the CATV head-end 110 to a plurality of cable-TV recipients, comprising, for example, the video display device 102. For example, the CATV distribution network 112 may comprise a network of fiber optics and/or coaxial cables that enable connectivity between the CATV head-end 110 and the video display device 102. The satellite-TV head-end 114 may comprise suitable logic, circuitry and/or code that may enable down link communication of satellite-TV signals to terrestrial recipients, such as the video display device 102. The satellite-TV head-end 114 may comprise, for example, one of a plurality of orbiting satellite nodes in a satellite-TV system. The satellite-TV receiver 116 may comprise suitable logic, circuitry and/or code that may enable reception of downlink satellite-TV signals transmitted by the satellite-TV head-end 114. Additionally, because most satellite-TV downlink feeds may be securely encoded and/or scrambled, the satellite-TV receiver 114 may also comprise suitable logic, circuitry and/or code that may enable decoding, descrambling and/or deciphering of received satellite-TV feeds.

The set-top box 118 may comprise suitable logic, circuitry and/or code that may enable processing of TV signals transmitted by one or more head-ends, for example the terrestrial-TV head-end 104, the CATV head-end 110 and/or the satellite-TV head-end 114, external to the video display device 102. The audiovisual device 120 may comprise suitable logic, circuitry and/or code that may enable inputting of video feeds into the video display device 102. For example, the audiovisual device 120 may comprise a personal video recorder (PVR) that may enable inputting, into the video display device 102, recorded video and/or audio feeds. Other examples of audiovisual devices may comprise a digital video disc (DVD) player, a digital video recorder (DVR), a video game console, a surveillance system, a personal computer (PC) capture/playback card and/or stand-alone CH3/4 modulator box.

In operation, the video display device 102 may be utilized to display video streams received from the audiovisual device 120 and/or from one of available head-ends. The video display device 102 may receive, via the TV antenna 100, over-the-air TV broadcast from the terrestrial-TV head end 104 transmitted via the TV tower 106. The video display device 102 may also receive cable-TV broadcast, which may be communicated by the CATV head-end 110 via the CATV distribution network 112. The video display device 102 may receive, via the satellite receiver 116, satellite TV broadcast, which may be communicated by the satellite head-end 114.

TV head-ends may utilize digital modulation format in TV broadcasts. Historically, TV broadcasts have utilized analog modulation format schemes, comprising, for example, NTSC, PAL and/or SECAM. Audio encoding may comprise utilization of separate modulation scheme, comprising, for example, BTSC, NICAM, mono FM and/or AM. More recently, however, there has been a steady move towards Digital TV (DTV), wherein digital modulation format schemes, comprising, for example, QAM, VSB, or OFDM, may be utilized for TV broadcasts to enable transmission and/or reception of video and/or audio streams as discrete signals. For example, the terrestrial-TV head-end 104 may be enabled to utilize ATSC and/or DVB based standards to facilitate DTV terrestrial broadcasts. Similarly, the CATV head-end 110 and/or the satellite head-end 114 may also be enabled to utilize appropriate digital standards to facilitate cable and/or satellite based DTV broadcasts.

The video display device 102 may be enabled to directly process DTV broadcasts to enable playing of corresponding video and/or audio streams. Alternatively, an external device, for example the set-top box 118, may be utilized to perform processing operations and/or functions, which may be operable to extract and playback the corresponding video and/or audio streams via the video display device 102. Because of digital characteristics of the received video stream, DTV capable systems may be enable to perform various operations and/or functionality that may not be available via analog systems. For example, the video display device 102 may be enabled, directly and/or via the set-top box 118, to perform various trick mode operations, which may comprise such operations as fast-forwarding, rewinding and/or reverse-playing.

In an exemplary aspect of the invention, display queue trick (DQT) modes may be utilized to enable improved and/or efficient performance of trick modes. The DQT modes may comprise utilizing various manipulation and/or queuing techniques of video frames during processing and/or decoding of received encoded media streams to provide quicker and more efficient processing. Use of DQT modes may enable use of smaller number of frames to perform trick mode operations with similar or improved picture rendition. For example, where a media stream may comprise an encoded video stream that comprises a plurality of frames and random access points (RAPs), one or more display queue trick (DQT) operations may be performed utilizing one or more decoded frames that are queued. The decoded frames are generated from a start of a random access point (RAP) in frame segment in the encoded video stream.

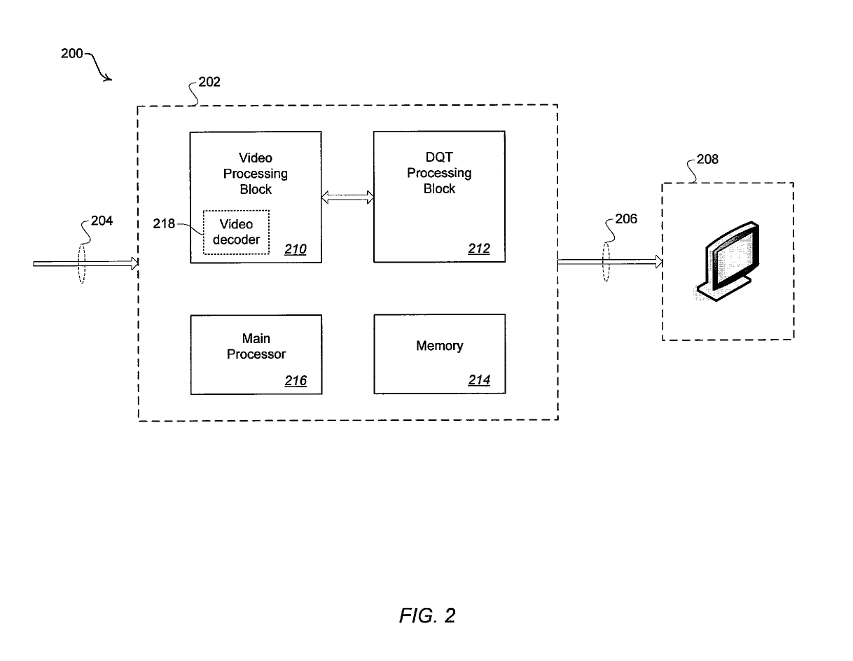

FIG. 2 is a block diagram that illustrates an exemplary system that utilizes display queue trick (DQT) modes to perform trick mode operations, in accordance with an embodiment of the invention. Referring to FIG. 2, there is shown a video system 200 comprising a processing subsystem 202, an input video stream 204, an output video stream 206, a display subsystem 208, a video processing block 210, a display queue trick (DQT) processing block 212, a memory 214, a main processor 216, and a video decoder 218.

The processing subsystem 202 may comprise the video processing block 210, the display queue trick (DQT) processing block 212, the memory 214, the main processor 216, and suitable logic, circuitry and/or code that may enable processing of video streams and/or to generate video playback streams.

The video processing block 210 may comprise suitable logic, circuitry and/or code that may enable performing video processing operations, including, for example decoding operations, which may be performed via the video decoder 218. The video decoder 218 may comprise suitable logic, circuitry and/or code that may be operable to decode video data encoded utilizing one or more encoding schemes. Exemplary video encoding schemes include MPEG-1/2, AVC and/or VC1. The video processing block 210 may be operable to process the input video stream 204, received via the video system 200, to enable generating the output video stream 206 for display via the display subsystem 208.

The display queue trick (DQT) processing block 212 may comprise suitable logic, circuitry and/or code that may enable performing, controlling, and/or managing DQT mode operations. The DQT processing block 212 is operable, for example, to manage processing of video streams, in conjunction with the video processing block 210, during forward and/or reverse DQT mode operations. The memory 214 may comprise suitable logic, circuitry and/or code that may enable storage and/or retrieval of data, code and/or instructions. The memory 214 is operable, for example, to enable queuing of data and/or storage of code and/or configuration data utilized during processing operations via the processing subsystem 202.

The main processor 216 may comprise suitable logic, circuitry and/or code that enable performing main control and/or management operations in the video processing subsystem 202. The main processor 216 is utilized to control at least a portion of the memory 214, the video processing block 210, and/or the DQT processing block 212. In this regard, the main processor 216 generates, for example, at least one or more signals for controlling operations within the video processing subsystem 202. The main processor 216 may also enable execution of applications that may be utilized by the video processing subsystem 202.

The display subsystem 208 may comprise suitable logic, circuitry and/or code that may enable performing display operations based on output video stream, generated via the processing subsystem 210. The display subsystem 208 and the processing subsystem 210 may be integrated within a single device, for example within the display device 102 when it is also operable to perform processing operations. Alternatively, the display subsystem 208 and the processing subsystem 210 may be integrated into different devices that may then be coupled to enable playback operations. For example, the display subsystem 208 may correspond to the display logic in the display device 102 whilst the processing subsystem 210 may be integrated within the set-top box 118. The input video stream 204 may comprise a data stream comprising video information.

The input video stream 204 may comprise, for example, an encoded video stream that comprises which may comprise a plurality of frames that may be logically grouped into a plurality of segments. The frame segments may be delineated by random access point (RAPs), which may correspond to points in the corresponding encoded bitstream wherein the video decoder 218 may be enabled to jump to and start decoding from without needing any prior data in the encoded bitstream. The output video stream 206 may comprise a stream of video data is that displayable via display logic. The output video stream 206 may comprise a frame stream that is suitable for display via the display subsystem 208.

In operation, the video system 200 may be utilized to enable performing video playback operations, including trick mode operations. The processing subsystem 202 may enable performing video processing operations, via the video processing block 210, which may enable, for example, decoding the input video stream 204 via the video decoder 218. The processing subsystem 202 may then enable generating the output video stream 206, which may be utilized to facilitate video playback via the display subsystem 208.

In an exemplary embodiment of the invention, the processing subsystem 202 may also be operable to enable processing encoded input video streams to facilitate performing trick mode operations utilizing DQT modes. The processing subsystem 202 is operable to receive the input video stream 204. During normal playback modes, the video processing block 210 is operable to process the input video stream 204 to enable, for example, extracting audio/video data and/or to decode encoded video data, via the video decoder 218 to enable the video processing subsystem 202 to generate playback streams communicated via output video stream 206 to the display subsystem 208 to enable playback operations. During trick mode operations, however, the DQT processing block 212 may be utilized, in conjunction with the video processing block 210, to facilitate performing one or more of DQT mode operations.

In an exemplary embodiment of the invention, the DQT processing block 212 may enable performing one or more display queue trick (DQT) operations utilizing one or more decoded frames, which may be queued. The decoded frames are generated from a start of a RAP in a frame segment in the encoded input stream 204. The DQT processing block 212 may, for example, enable forward trick mode operations wherein a RAP may first be selected within the encoded input stream 206, then only subset of frames within frame segment starting from the RAP may be decoded, via the video decoder 218 in the video processing block 210. The decoded frames may then be queued via the memory 214. The queued frames may then be sent, via the output video stream 206, to the display subsystem 208 for playback. The DQT processing block 212 may then determine a next RAP where the video decoder may jump to decode another set of frames within a next frame segment, wherein the decoded frames are queued and used. The DQT processing block 212 may be similarly operable to enable performing reverse trick mode operations utilizing the video processing block 210 and the memory 214 to perform decoding and queuing functions during these operations. The video decoder 218 and/or the DQT processing block 212 may also be operable to discard at least some of the frames which may be used during DQT operations. For example, the video decoder 218 may select, based on decoding performance requirement, storage constrains, and/or discardability criteria, frames which may be discarded without adversely affecting DQT operations and/or operational requirements of video decoding protocols. In addition, while the invention has been described hereto such that generation of decoded frames, via the video decoder 218, is performed subsequent to determination of RAPs by the DQT processing block 212, the invention need not be limited to such implementation. Instead, segments of the input video stream 204 may be fed into the video decoder 218 with no correlation to RAPs. The video decoder 218 may then be operable to determine and/or seek RAPs, during decoding of the fed data, to enable decoding frames that may then be used to perform DQT operations.

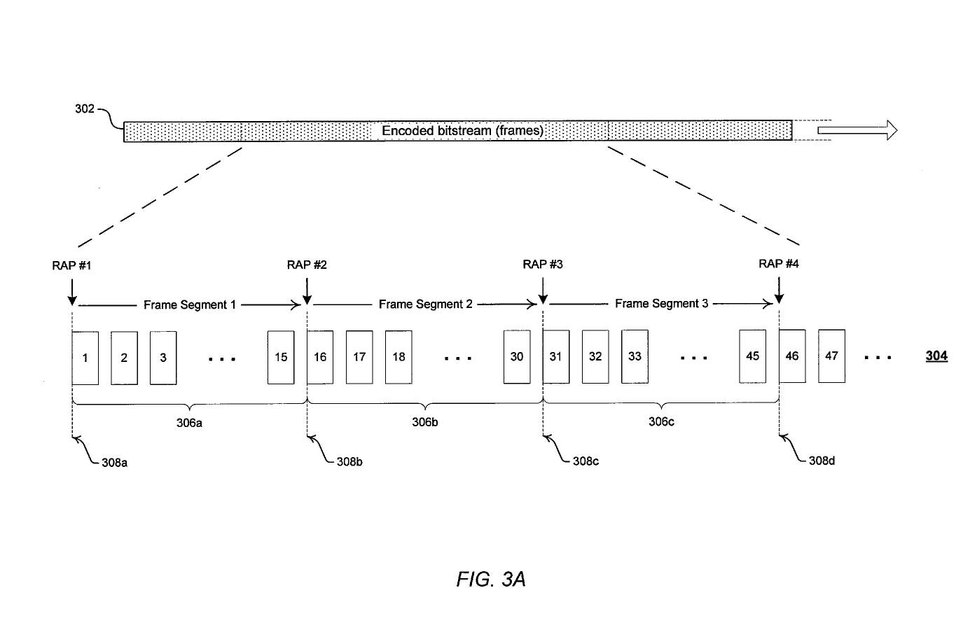

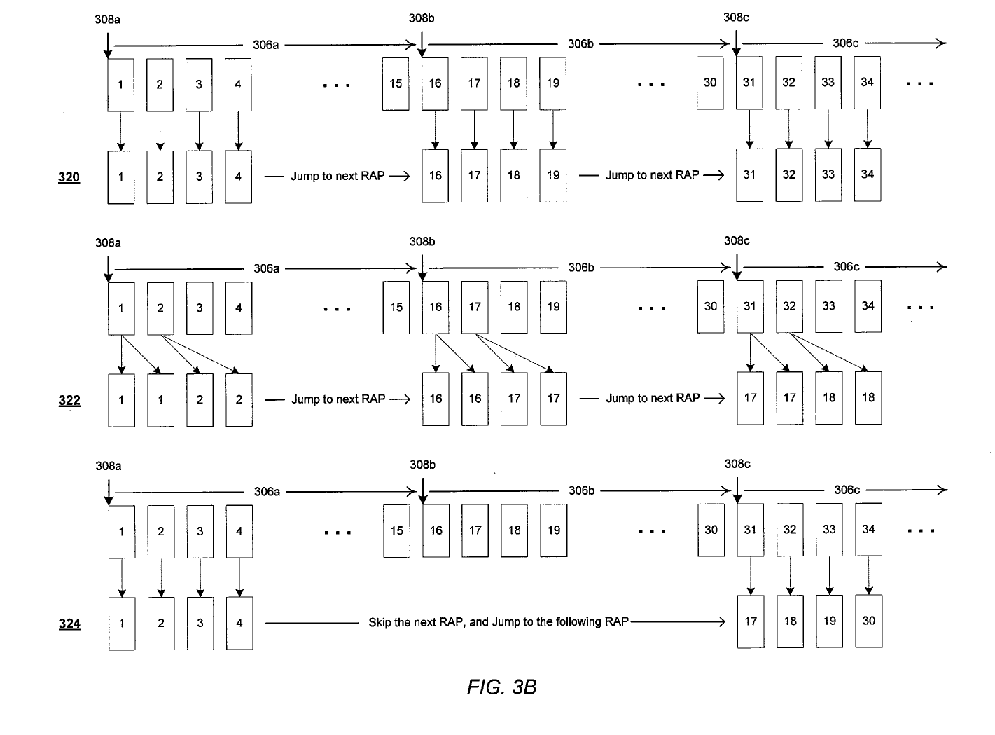

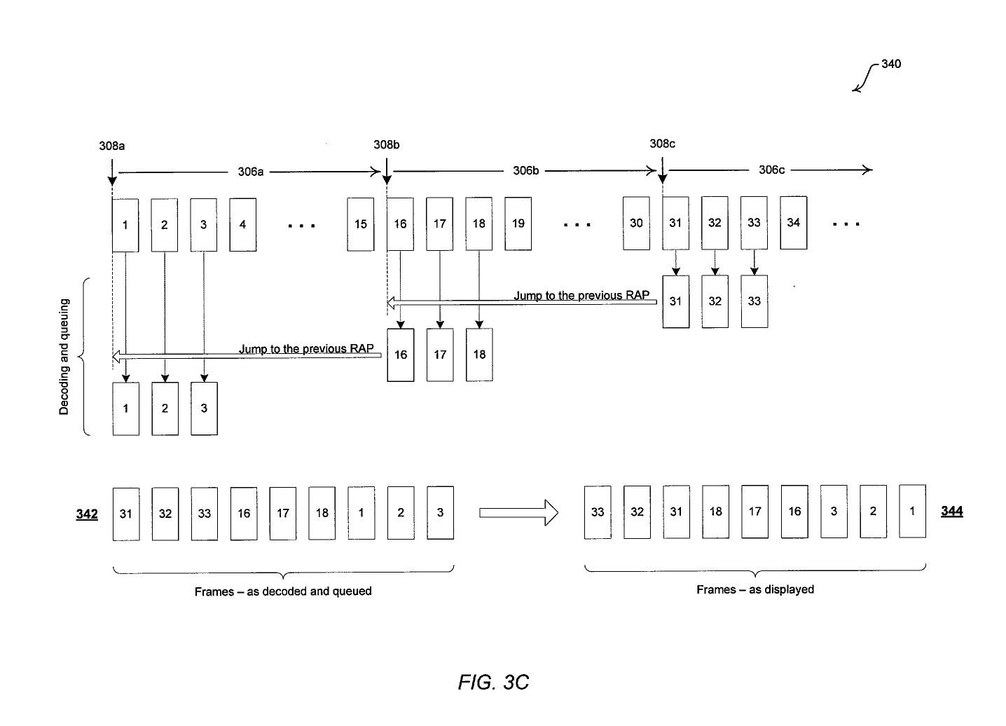

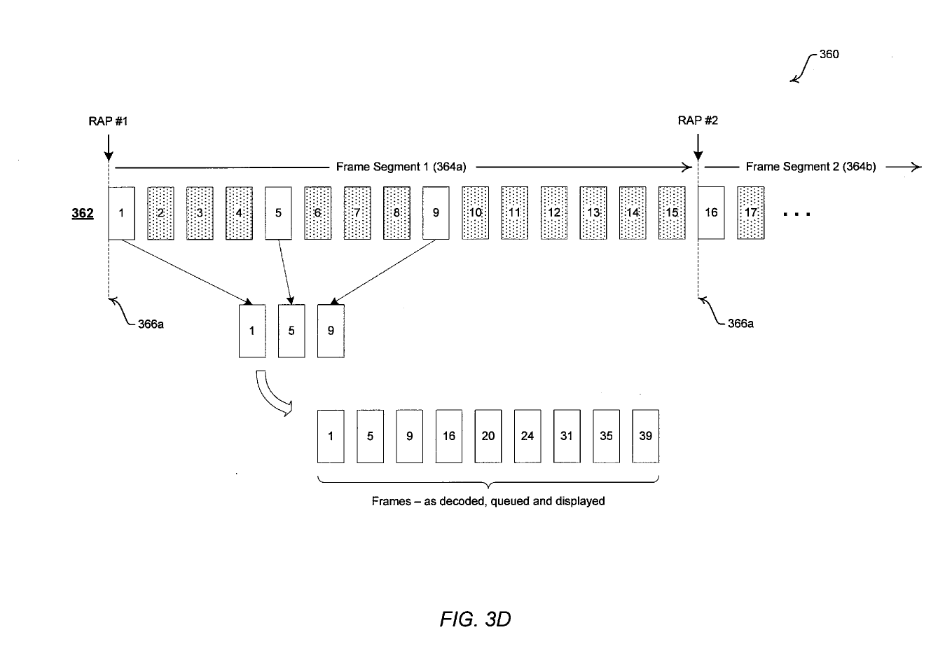

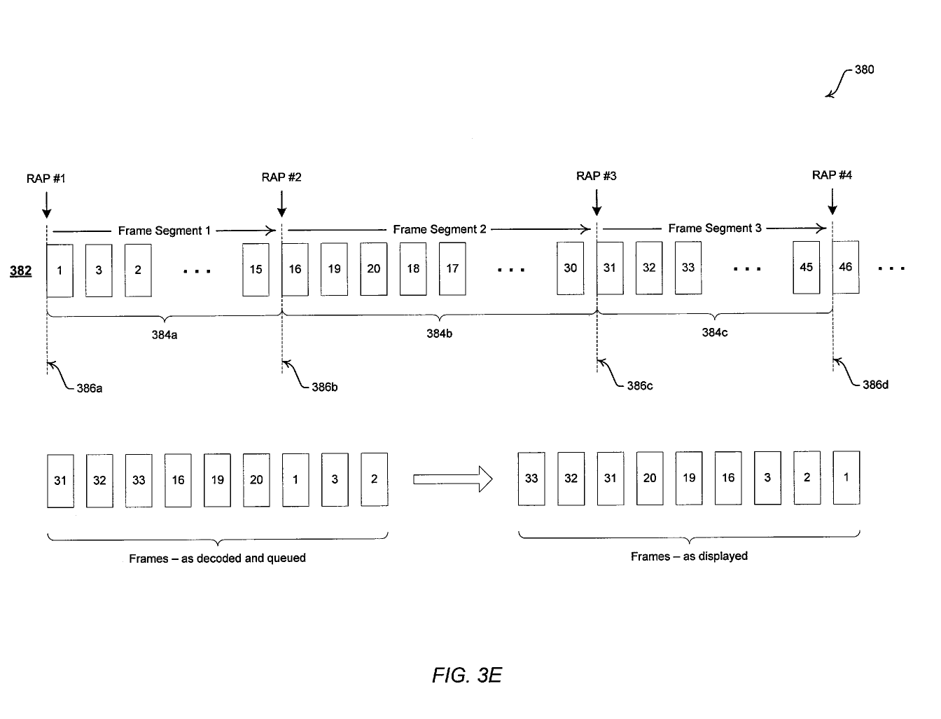

FIG. 3A is a block diagram that illustrates an encoded bitstream that corresponds to a frame stream with random access points, which may be utilized in accordance with an embodiment of the invention. Referring to FIG. 3A there is shown an encoded bitstream 302, a frame stream 304, a plurality of frame segments 306a, . . . , 306c, and a plurality of random access points (RAPs) 308a, . . . , 308d. The encoded bitstream 302 may comprise encoded data that may be utilized to communication media streams. The encoded bitstream 302 may be utilized, for example, to facilitate DTV broadcast via, for example, the terrestrial-TV head-end 104, the cable-TV (CATV) head-end 110 and/or the satellite-TV head-end 114. The encoded audio/video data carried via the encoded bitstream 302 may be structured as a plurality of frames. For example, in instances where the audio/video information is MPEG-1/2 encoded, the audio/video data in the encoded bitstream 302 may comprise I-frames, P-frames and/or B-frames. The encoded bitstream 302 may comprise the frame stream 304, which comprise encoded video data communicated via the encoded bitstream 302. The frame stream 304 may comprise a plurality of frames, which may be logically grouped into a plurality of frame segments, including the frame segments 306a, . . . , 306c, each of which comprising one or more encoded video frames. The frame stream 304 may also comprise a plurality of random access points (RAPs), comprising the RAPs 308a, . . . , 308d, which may correspond to points which a decoder, for example the video decoder 218, may be enabled to jump to and start decoding from without needing any prior data in the frame stream 304.

In operation, the encoded bitstream 302 may be processed, via the video system 200 for example, to extract a frame stream 304 which may comprise video data that may be played, for example, via the display subsystem 208. The frame segments in the frame stream 304, for example the frame segments 306a, . . . , 306c, may be decoded and utilized independently via the video decoder 218. The video decoder 218 may be enabled to jump to RAPs in the video stream 304, for example the RAPs 308a, . . . , 308c and process the frame segment starting at the corresponding RAP, for example the frame segments 306a, . . . , 306c. For example, in instances where the video data is MPEG-1/2 encoded, the RAPs 306a, . . . , 306b may correspond to the beginning of the I-frames within the encoded bitstream. The frame segments in an MPEG-1/2 encoded stream, for example, may correspond to logical frame groupings comprising I-frames and their dependent P-frames and/or B-frames. In various embodiments of the invention, the RAPs may enable utilizing display queue trick (DQT) techniques to perform various trick mode operations. DQT enabled decoders, for example the video decoder 218 where utilized in conjunction with the DQT processing block 212, may be enabled to utilize the RAPs to determine points from which a set of frames may be selected for decoding and/or display during DQT modes operations.

FIG. 3B is a block diagram that illustrates various methods in utilizing display queue trick (DQT) modes to perform forward trick mode operations, in accordance with an embodiment of the invention. Referring to FIG. 3B, there is shown charts 320, 322 and 324 demonstrating various DQT techniques that enable performing forward trick mode operations using the frame stream 304, substantially as described with regard to FIG. 3A.

In operations, the DQT techniques shown in charts 320, 322 and/or 324 may enable forward trick modes, comprising fast forward operations, using, for example, the frame stream 304. The number of frames that may be decoded, queued and/or used during DQT mode operations within frame (DQT) segments may be determined based on a plurality of factors and/or considerations, which may be predetermined and/or dynamically determined, user specified and/or may be mandated by system requirements, parameters and/or limitations. For example, the number of frames in the frame stream 304 that may need be processed and/or used during fast-forward operations in the video system 200 may depend on the fast-forward speed requested by users and/or supported via display devices. Additionally, memory and/or processing limitations and/or requirements may also be relevant to performing DQT operations. For example, limited memory and/or processing resources, via the memory 214 and/or the main processor 216 in the video system 200, may necessitate decoding fewer frames which may then be used in a manner that achieves the required display effect, by reusing the same frame more than once for example. In chart 320, a subset of frames within each frame (DQT) segment in the frame stream 304 may be utilized to perform forward trick modes via the video system 200. For example, where the frame (DQT) segments may comprise 15 frames, the video decoder 218 may first start at the first RAP 308a, and may then decode the first 4 frames in the frame (DQT) segment 306a, based on input from the DQT processing block 212. The decoded frames may then be queued, via the memory 214, and subsequently utilized, in order, via display logic, for example the display subsystem 208, to achieve required trick mode effects. The DQT processing block 212 may then enable the video decoder 218 to jump to the following RAP 308b, and may again decode, queue and utilize the first 4 frames, in order in the frame (DQT) segment 308b. The video decoder 218 may continue to jump to each RAP in the stream of frames 304, in order, and repeat the same steps as long as the forward trick mode is requested, based on input provided via the DQT processing block 212.

In instances where fewer frames are needed and/or where processing and/or storage requirements and/or availability, via the memory 214 and/or the main processor 216 for example, limit the number of frames that may be decoded, other methods may be utilized to achieve similar trick mode effects. In chart 322, for example, at least some decoded frames may be redisplayed and/or repeated to achieve a particular frame or picture rate. In an exemplary embodiment of the invention, the video decoder 218 may start at the first RAP 308a, and may then decode only 2 frames within the first frame (DQT) segment 306a, based on input from the DQT processing block 212. The decoded frames may then be queued, via the memory 214, and each frame may subsequently be displayed twice, via the display subsystem 208, to achieve the display effect of using four frames.

The video decoder 218 may then jump to each following RAP and repeat the same steps, decoding and queuing two frames but displaying each frame twice to achieve display effect of use of four frames. Alternatively, some RAPs may be skipped to enable using fewer frames overall and generating smaller frame rate compared to chart 320 while still utilizing the same number of frames per frame (DQT) segment as illustrated in chart 320. In chart 324, for example, alternate RAPs may be skipped to enable decoding and using half as many frames as used in chart 320 while maintaining comparable display characteristics. For example, the video decoder 218 may start at the first RAP 308a, and may decode, queue via the memory 214 and subsequently utilize four frames within the first frame (DQT), segment 306a, based on input from the DQT processing block 212, in order, via the display subsystem 208 to achieve required trick mode effects. The video decoder 218 may then skip the next RAP 308b, and jump to the following RAP 308c. The video decoder 218 may then decode, queue and use four frames in the frame (DQT) segment 306c. The video decoder 218 may continue to skip every other RAP jumping to the following RAP to repeat the same step.

The invention is not limited to use of the techniques shown in charts 320, 322 and 324 to facilitated use of DQT modes to perform forward trick mode operations. In other embodiments of the invention, other criteria may be utilized to determine, via the DQT processing block 212 in the video system 200 for example, selection of frames for decoding within frame (DQT) segments, use of frames during display operations to enable DQT modes and/or choice of RAPs which a decoder jumps to and/or frame (DQT) segments that are used or not. Additionally, a combination of some and/or all available DQT techniques may be utilized during performance of DQT modes.

FIG. 3C is a block diagram that illustrates use of display queue trick (DQT) modes to perform reverse trick mode operations, in accordance with an embodiment of the invention. Referring to FIG. 3C, there is shown chart 340 demonstrating use of DQT modes to perform reverse trick mode operations using the frame stream 304, substantially as described with regard to FIG. 3A.

In operations, the DQT techniques illustrated in chart 340 may be operable to enable reverse trick modes, using, for example, the frame stream 304. The number of frames that are decoded, queued and/or used during the DQT modes within frame (DQT) segments may be determined based on a plurality of factors and/or considerations, which may be predetermined, user specified and/or may be mandated by system requirements, parameters and/or limitations. For example, the number of frames in the frame stream 304 that need be processed and/or used during rewind operations in the video system 200 may depend on the rewind speed requested and/or supported via the display device. Additionally, memory and/or processing limitations and/or requirements may also be relevant to performing DQT operations. For example, limited memory and/or processing resources, via the memory 214 and/or the main processor 216 in the video system 200, may necessitate decoding fewer frames which may then be used in a manner that achieves the required display effect.

In chart 340, a subset of frames within each frame (DQT) segment in the frame stream 304 may be utilized to perform reverse trick modes. For example, where the frame (DQT) segment may comprise 15 frames, the video decoder 218 may jump to a RAP, for example RAP 308c, and may then decode the first 3 frames in the frame (DQT) segment 306c, based on input from the DQT processing block 212. The decoded frames may then be queued, via the memory 214 and subsequently utilized, in reverse order starting with the later frame and going backwards towards the RAP, via the display subsystem 208 to achieve required reverse trick mode effects. The video decoder 218 may then jump to the preceding RAP 308b, and may again decode, queue, and utilized the first 3 frames in reverse order in the frame (DQT) segment 306b. The video decoder 218 may continue to jump to each preceding RAP within the frame steam 304 and repeat the same steps as long as the reverse trick mode is requested, based on input provided via the DQT processing block 212.

The invention is not limited to use of the techniques shown in chart 340 to facilitated use of DQT modes to perform reverse trick mode operations. In other embodiments of the invention, other criteria may be utilized to determine, via the DQT processing block 212 in the video system 200 for example, selection of frames for decoding within frame (DQT) segments, use of frames during display operations to facilitate performing reverse DQT modes and/or choice of RAPs which the video decoder 218 jumps to and/or frame (DQT) segments that are used or not. A combination of some and/or all available DQT techniques may be utilized during performance of reverse DQT modes.

FIG. 3D is a block diagram that illustrates use of display queue trick (DQT) modes to perform trick mode operations with video streams that comprise reference and discardable frames, in accordance with an embodiment of the invention. Referring to FIG. 3D, there is shown chart 360 demonstrating use of DQT modes to perform reverse trick mode operations using a frame stream 362. The frame stream 362 may be substantially similar to the frame stream 304, as described in FIG. 3A. The frame stream 362 may comprise a plurality of frames grouped into frame segments, including for example frame segments 364a and 364b, which are delineated by the RAPs 366a and 366b to enable a video decoder, for example the video decoder 218 to jump to points in the frame stream 362 to initiate decoding operations independent of previous or subsequent data in the stream. The frame segments in frame stream 362, however, may comprise reference, non-discardable and/or discardable frames. In the frame segment 364a, for example, frame 1 may be a reference frame comprising video data that may be reusable during decoding and/or use of remaining frames in the frame segment 364a. Consequently, preference may be given to reference frames during decoding operations because such frame may enable use of other frames with minimal decoding and/or processing. The frames 5 and 9 may comprise non-reference but non-discardable frames. For example, where the frame stream 362 corresponds to MPEG-1/2 encoded data, for example, the stream of frame 362 may comprise a plurality of reference frames, the I-frames, and plurality of dependent frames, the P-frames and/or B-frames, wherein at least some of the dependent frames may be discardable, for example the B-frames. The I-frames are usable independent of other frames and comprise complete video and/or audio data. The B-frames and/or P-frames may comprise data that enable performing video and/or audio playback by referencing data comprised in other frames.

In operations, the DQT techniques shown in charts 360 may enable performing forward trick mode, comprising fast forward operations, in frame streams with reference and discardable frames, for example the frame stream 362. For example, the DQT processing block 212 in the video system 200 may be operable to determine frames in the frame stream 362 that may need be processed and/or used during forward trick mode operations in the video system 200. The determination of frames that may be used may be based, at least in part, on categorization of frames in the frame stream 362 as reference or discardable frames. Additionally, because of the discardable nature of at least some of the frames within each frame segments in the frame stream 362, frames that may be chosen during DQT mode operations may not be contiguous. For example, frames 1, 5 and 9 may comprise non-discardable frames within the stream segment 366a because they may comprise reference frames and/or non-discardable frames.

In chart 360, a subset of non-contiguous frames within each frame (DQT) segment in the frame stream 362 may be utilized to perform forward trick modes wherein selected frames may comprise at least a reference frame, and unselected frame may comprise, for example, discardable frames in the same frame segment. For example, the video decoder 218 may start at the first RAP 366a, and may then decode and queue, via the memory 214, the first frame, frame 1, which may represent a reference frame in the first frame (DQT) segment 364a, based on input provided via the DQT processing block 212. The video decoder 218 may then decode and queue two more frames within the first frame (DQT) segment, for example frames 5 and 9, wherein frames 5 and 9 enable reusing some of the video and/or audio data provided via frame 1. Remaining frames in the frame (DQT) segment 364a may then be discarded. The three decoded and queued frames may then be utilized, in order, via the display subsystem 208. The video decoder 218 may then jump to the following RAP 366b, and may again decode and queue the reference frame and two more frames in the frame (DQT) segment 364b, wherein the selected frames may not be contiguous frames within the frame (DQT) segment 364b. The video decoder 218 may then utilize the decoded frames, in order, for display via the display subsystem 208. The video decoder 218 may continue to jump to each RAP in the frame steam 362, in order, and repeat the same steps as long as the forward trick mode is requested.

The invention need not be limited to the embodiment described, and in other embodiments of the invention, other criteria may be utilized to determine, via the DQT processing block 212 for example, selection and/or discarding of frames within frame (DQT) segments, order of use of frames during display operations to facilitate performing DQT modes and/or choice of RAPs which a decoder jumps to and/or frame (DQT) segments that may be used or not. Additionally, a combination of some and/or all available DQT techniques may be utilized during performance of DQT modes.

FIG. 3E is a block diagram that illustrates use of display queue trick (DQT) modes to perform trick mode operations with video streams with different encoding/display orders, in accordance with an embodiment of the invention. Referring to FIG. 3E, there is shown chart 380 demonstrating use of DQT modes to perform trick mode operations using a frame stream 382.

The frame stream 382 may be similar to the frame stream 304, substantially as described in FIG. 3A. The frame stream 382 may similarly comprise a plurality of frames, which may be grouped into a plurality of frame segments, for example frame segments 384a, . . . , 384c, each of which comprised of a subset of frames within the frame stream 382. RAPs, for example RAPs 386a, . . . , 386d, may enable a video decoder, for example the video decoder 218, to jump to the start of the frame segments within the frame stream 382. The frame stream 382, however, may comprise frames of differing order for decoding and/or use. For example, within the frame segment 384a in the frame stream 382, frame 3 is decoded before frame 2 whilst frame 2 is displayed before frame 3. The variation of the display and decoding order may be due to the encoding scheme used to generate the encoded data stream. For example, frame 2 may comprise data that are provided in reference to data included in frames 1 and 3, providing, for example, variation in video attribute from data provided in frames 1 and 3. Accordingly, decoding frame 2 may require that frames 1 and 3 are decoded first to enable determining applicable video and/or audio data necessary to playback frame 2.

In operations, DQT techniques shown in chart 380 may be operable to enable performing trick modes using the frame stream 382. The number of frames that are decoded, queued and/or used during DQT modes operations within frame (DQT) segments may be determined based on a plurality of factors and/or considerations, which may be predetermined, user specified and/or may be mandated by system requirements, parameters and/or limitations. For example, the number of frames that need to be processed and/or used during fast-forward operations may depend on the forwarding speed requested by users and/or supported via display devices. Additionally, memory and/or processing limitations and/or requirements may also be relevant to performing DQT operations, necessitating, for example, fewer frames may be decoded but then used in a manner that achieves the required display effect. In chart 280, a subset of frames within each frame (DQT) segment in the frame stream 282 may be utilized to perform trick modes. For example, the video decoder 218 may jump to a RAP in the frame stream 382, and may then decode the first 3 frames in the frame (DQT) segment starting at that RAP, in the order of the frames within the encoded frame stream 382. The decoded frames may then be queued in the memory 218, in the same order the frame were decoded for example. The queued frames may then be utilized via the display subsystem 208 to facilitate trick modes. During use of the queued frames, however, the intended order of display of the frames during normal operations may first be considered to determine the correct order of use during trick modes.

In an exemplary embodiment of the invention, during reverse trick mode operations, the forward display order of the queued frames 1, 2 and 3 may be determined first when determining the order in which the frames may be read from the queue and/or in which the frames may be used and displayed in order to facilitate the proper reverse order of display while performing reverse trick modes. Consequently, frame 3 is read out and/or used first, then frame 2 then frame 1. The video decoder 218 may then jump to subsequent RAPs, for example RAPs 386b and 386b, and may decode the first 3 frames within the corresponding frame (DQT) segments, for example 384b and 384c, wherein the proper display order may be considered during use of the frames to facilitate performing DQT mode operations.

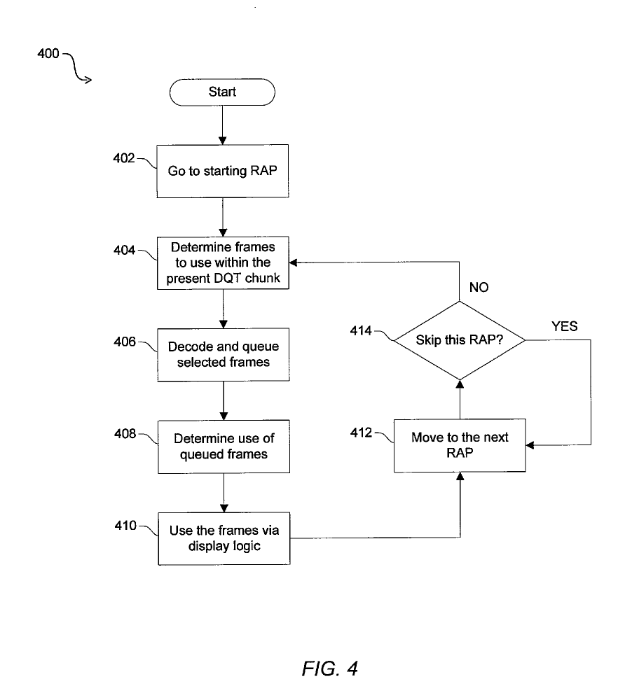

FIG. 4 is a flow chart that illustrates use of display queue trick (DQT) modes to perform trick mode operations, in accordance with an embodiment of the invention. Referring to FIG. 4, there is shown a flow chart 400 comprising a plurality of exemplary steps, which may enable use of DQT modes to perform trick mode operations. The exemplary steps may be utilized, for example, via the DQT processing block 212, substantially as described with regards to FIG. 2, to enable performing DQT mode operations while processing an encoded frame stream, for example the frame stream 304.

In step 402, DQT mode operations may be initiated by jumping to the start RAP in the frame stream. The starting RAP may refer to the RAP at which the trick mode operations may proceed. For example, the video decoder 218 may be operable to jump to the RAP 308a in the frame stream 304 during forward trick modes operations or to RAP 308c during reverse trick modes operations. The trick mode operations may require jumping to preceding and/or subsequent RAPs within the encoded frame stream based on, for example, whether it is forward or reverse trick modes operations. In step 404, the frames that may be used for DQT mode operations within the frame segment delineated by the RAP may be determined. For example, during DQT mode operations utilizing the frame stream 304, the DQT processing block 212 may be operable to select a subset of the frames within frame (DQT) segments 306a, . . . , 306c that may be utilized to facilitate performing the required DQT modes operations. Video decoding may also be performed without prior determination of RAPs. For example, the frame stream 304 may be fed directly into the video decoder 218 with no correlation to RAPs. The video decoder 218 may then be operable to determine presence of and/or seek location of RAPs, during decoding of the fed data, to enable decoding frames that may then be used to perform DQT operations. The number of frames and/or criteria for selecting the frames that may be decoded and/or used during DQT operations within frame (DQT) segments may be determined based on a plurality of factors and/or considerations, which may be predetermined, user specified and/or may be mandated by system requirements, parameters and/or limitations.

In step 406, the selected frames may be decoded and queued. For example, the video processing block 210 may be operable to decode, via the video decoder 218, the encoded frames selected via the DQT processing block 212. The video decoder 218 and/or the DQT processing block may be operable, however, to discard some of the selected frames, based on, for example, decoding performance requirement, storage constrains, and/or discardability criteria. The decoded frames may then be queued, via the memory 214 for example. In step 408, the manner of use of the decoded and queued frames to facilitate DQT trick mode operations may be determined. For example, the intended and/or required usage order of the decoded frames within the encoded frame stream 304 during normal operation may be ascertained. This may be utilized to determine, via the DQT processing block 212 for example, a usage order for queued and decoded frames for DQT mode operations, which is necessary to facilitate the trick mode effect, by reversing the order of use, for example, during reverse trick modes.

In step 410, the decoded and queued frames may be utilized, according to the order and/or manner of use, via display logic. For example, the decoded frames queued via the memory 214 may be displayed via the display subsystem 208 in the video system 200 based on input provided via the DQT processing block 212 for example. In step 412, the processing may proceed to the next RAP. The next RAP may be a preceding or a subsequent RAP. For example, during forward trick modes, the video decoder 218 may be enabled to jump to RAP 308b once decoding, queuing and use of frames in the frame segment 306a is complete. In step 414, a determination may be made whether to use frames within the frame (DQT) segment delineated by the present RAP. For example, once the video decoder 218 jumps to RAP 308b, the DQT processing block 212 may be operable to provide input whether the frame segment 306b is to be used or not during DQT modes operations, substantially as described in FIG. 3B. In instances where the RAP may be skipped, the exemplary steps may proceeds back to step 412.

Returning to step 414, in instances where the present RAP is not skipped, the exemplary steps may proceeds back to step 404, wherein frames may be utilized to perform DQT mode operations within the present frame (DQT) segment.

Various embodiments of the invention may comprise a method and system for enabling video trick modes. The video system 200 is operable to perform one or more display queue trick (DQT) operations utilizing decoded frames, which may be queued, for example via the memory 214 in the video system 200. The video system 200 may be integrated in the display device 102 and/or the set-top box 118 to enable performing DQT modes utilizing, for example, digitally encoded TV broadcasts received from the terrestrial head-end 104, the CATV head-end 110 and/or the satellite head-end 114. Exemplary encoding schemes which may be utilized to encode the video streams utilized during DQT modes may comprise MPEG, AVC and/or VC1. The used frames may be decoded via the video decoder 218 in the video processing block 210. The encoded frames may be generated from start of random access points (RAPs) in frame segments in an encoded video stream which comprises a plurality or RAPs, for example from RAPs 308a, . . . , 308c in the frame segments 306a, . . . , 306b in the frame stream 304 within the encoded bitstream 302. The DQT modes may comprise forward and/or reverse display modes, and may comprise such operations as fast-forwarding, rewinding and/or reverse-playing.

The frames utilized during DQT modes may be selected based on determination, via the DQT processing block 212 in the video system 200 for example, of DQT mode parameters, queuing limitations and/or frame properties of selected and/or unselected frames in the frame segments. The factors and/or considerations that may be relevant to selection of frames during DQT modes may be predetermined, dynamically determined, user specified and/or mandated by the video system 200 requirements, parameters and/or limitations. For example, processing and/or queuing limitations in the video system 200 may affect number of frames that may be decoded and/or stored to effectuate a required effect during DQT modes. Exemplary parameters for the DQT modes may comprise speed of display, direction, quality of motion rendition and/or desired visual effect. Frame properties may comprise decoding and/or display order, frame discardability and/or display inter-frame dependencies between selected and/or unselected frames.

The used frames may be selected from the start of the RAPs 308a, . . . , 308c in the frame segments 306a, . . . , 306c during forward and/or reverse trick modes. Additionally, in instances where the frame steams comprise one or more discardable frames, for example frame stream 362, non-contiguous frames within the frame segments, for example the frame segment 364a, may be selected during DQT modes. The video system 200 may be operable to jump to preceding and/or subsequent RAPs during DQT mode operations to facilitate use of frames in subsequent and/or preceding frame segments, respectively. The video system 200 may also be operable to skip one or more RAPs, for example RAP 308b, during jumps between frame segments 306a and 306c during DQT modes.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for enabling video trick modes.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
performing one or more display queue trick (DQT) operations utilizing one or more decoded frames that are queued, wherein said decoded frames are generated from a start of a random access point (RAP) in a frame segment in an encoded video stream that comprises a plurality of random access points (RAPs).

2. The method according to claim 1, comprising decoding said one or more frames from said start of said random access point in said frame segment in said encoded video stream.

3. The method according to claim 2, comprising queuing said one or more decoded frames in memory.

4. The method according to claim 1, comprising selecting said one or more frames based on determination of DQT mode parameters, queuing limitations and/or frame properties of selected and/or unselected frames in said frame segment.

5. The method according to claim 4, comprising performing said selection and/or determination dynamically and/or adaptively.

6. The method according to claim 4, wherein said parameters of DQT modes comprise speed of display, direction, quality of motion rendition and/or desired visual effect.

7. The method according to claim 4, wherein said frame properties comprise frame discardability and/or display inter-frame dependencies among selected and/or unselected frames.

8. The method according to claim 1, comprising jumping to another RAP in said plurality of random access points, wherein said another RAP precedes or follows said RAP.

9. The method according to claim 8, comprising skipping one or more RAPs between said another RAP and said RAP during said RAP jumping.

10. The method according to claim 1, comprising determining location of said RAPs during decoding of said encoded video stream.

11. A system for video processing, the system comprising:
one or more circuits operable to perform one or more display queue trick (DQT) operations utilizing one or more decoded frames that are queued in memory, wherein said decoded frames are generated from a start of a random access point (RAP) in a frame segment in an encoded video stream that comprises a plurality of random access points (RAPs).

12. The system according to claim 11, wherein said one or more circuits are operable to decode said one or more frames from said start of said random access point in said frame segment in said encoded video stream.

13. The system according to claim 12, wherein said one or more circuits are operable to queue said one or more decoded frames in said memory.

14. The system according to claim 11, wherein said one or more circuits are operable to select said one or more frames based on determination of DQT mode parameters, queuing limitations and/or frame properties of selected and/or unselected frames in said frame segment.

15. The system according to claim 14, wherein said one or more circuits are operable to perform said selection and/or determination dynamically and/or adaptively.

16. The system according to claim 14, wherein said parameters of DQT modes comprise speed of display, direction, quality of motion rendition and/or desired visual effect.

17. The system according to claim 14, wherein said frame properties comprise frame discardability and/or display inter-frame dependencies among selected and/or unselected frames.

18. The system according to claim 11, wherein said one or more circuits are operable to jump to another RAP in said plurality of random access points, wherein said another RAP precedes or follows said RAP.

19. The system according to claim 18, wherein said one or more circuits are operable to skip one or more RAPs between said another RAP and said RAP during said RAP jumping.

20. The system according to claim 11, wherein said one or more circuits are operable to determine location of said RAPs during decoding of said encoded video stream.
